(19) United States
(12) Patent Application Publication
(10) Pub. No.: US 2010/0266906 A1
(43) Pub. Date: Oct. 21, 2010

(54) BIOFUEL BATTERY AND PROCESS OF PREPARING THE SAME

(76) Inventors: Maryam Otadi, Tehran (IR); Sina Poormohammdian, Tehran (IR)

Correspondence Address: CHOOBIN & CHOOBIN CONSULTANCY L.L.C;Barry Choobin, Green Community, Building 3, Ground Floor, Dubai Investment Park, P.O Box 212880, Dubai, AE

(21) Appl. No.: 12/830,291

(22) Filed: Jul. 3, 2010

Related U.S. Application Data
(60) Provisional application No. 61/290,036, filed on Dec. 24, 2009.

(51) Int. Cl. H01M 8/16

(52) U.S. Cl. 429/401; 429/535

(57) ABSTRACT

The various embodiments herein provide a biofuel battery having a fuel, electrode and water and its manufacturing method. The biofuel battery comprises a bio fuel as a negative electrode, dissolved oxygen in water as a positive electrode and water as an electrolyte. The carbohydrate is used as bio mass for generating electron in the bio cell. The biofuel battery produces maximum amount of 1 volt electricity under the optimal conditions.

The present application claims the benefit of U.S. Provisional Application 61/290,036, filed on Dec. 24, 2009, whose content is incorporated by reference herein in its entirety.

### BACKGROUND

1. Technical field

The embodiments herein generally relates to batteries and particularly to biofuel batteries. The present invention more particularly relates to a carbohydrate based bio fuel battery which uses all natural solid materials having large amount of carbohydrate and the manufacturing method of a biobattery.

2. Description of the Related Art

Biofuels are a wide range of fuels which are in some way derived from a biomass. The term covers solid biomass, liquid fuels and various biogases. Biofuels are gaining increased public and scientific attention, driven by factors such as oil price spikes and the need for increased energy security.

A microbial fuel cell (MFC) or biological fuel cell is a bio-electrochemical system that drives a current by mimicking bacterial interactions found in nature. Mediator-less MFCs are a much more recent development and due to this the factors that affect optimum operation, such as the bacteria used in the system, the type of ion membrane, and the system conditions such as temperature, are not particularly well understood. Bacteria in mediator-less MFCs typically have electrochemically-active redox enzymes such as cytochromes on their outer membrane that can transfer electrons to external materials.

A microbial fuel cell is a device that converts chemical energy to electrical energy by the catalytic reaction of microorganisms. A typical microbial fuel cell consists of anode and cathode compartments separated by a cation (positively charged ion) specific membrane. In the anode compartment, fuel is oxidized by microorganisms, generating electrons and protons. Electrons are transferred to the cathode compartment through an external electric circuit, and the protons are transferred to the cathode compartment through the membrane. Electrons and protons are consumed in the cathode compartment, combining with oxygen to form water. In general, there are two types of microbial fuel cells: mediator and mediator-less microbial fuel cells.

Microbial fuel cells have a number of potential uses. The first and most obvious is harvesting the electricity produced for a power source. Virtually any organic material could be used to ‘feed’ the fuel cell.

Biological fuel cells (biofuel cells) use biocatalysts like bio-molecules such as enzymes or even whole living organisms (microbes) to catalyze oxidation of biomass-based materials for generating electrical energy. Biofuel cells are highly renewable and capable of using naturally available biomass as fuel. As a result, they are an excellent alternative to conventional fuel cells (and batteries) that are plagued by non-renewability, non-implantability, size/weight, operating conditions (high temperature, acidity and toxicity), waste issues and logistics. This makes them ideal for use in portable applications, military settings, as well as for rural deployment.

Carbohydrates (CHO) are a category of compounds derived from plant foods which provide one molecule of water with each carbon. Carbohydrates are an ideal source of energy for the body and are naturally occurring compounds that consist of carbon, hydrogen and oxygen. Carbohydrates are produced by one of the most complex, vital and amazing processes in the physical world called photosynthesis. Photosynthesis involves the conversion of carbon dioxide and water to sugars, which, along with starches and cellulose, are some of the more well known varieties of carbohydrate. Since they are an integral part of plant life, it is no wonder that carbohydrates are in most fruits and vegetables although they are not a dietary requirement in the way that vitamins or essential amino acids are.

Starches are complex carbohydrates without taste or odor and are granular or powdery in physical form. Complex carbohydrates are long chains of simple sugar units bonded together and for this reason the complex carbohydrates are often referred to as polysaccharides. Starch is the principal polysaccharide used by plants to store glucose for later use as energy. They are found naturally in foods and also refined in processed foods. Complex carbohydrates as natural starches are found in bananas, barley, beans, brown rice, chickpeas, lentils, nuts, oats, parsnips, potatoes, root vegetables, sweet corn, whole grain cereals, whole meal breads, whole meal cereals, whole meal flour, whole meal pasta and yams. Complex carbohydrates as refined starches are found in biscuits, pastries and cakes, pizzas, sugary processed breakfast cereals, white bread, white flour, white pasta, white rice.

Biofuels are produced from living organisms or from metabolic by-products (organic or food waste products). In order to be considered as a biofuel, the fuel must contain over 80 percent renewable materials. It is originally derived from the photosynthesis process and can therefore often be referred to as a solar energy source. There are many pros and cons in using biofuels as an energy source.

‘First-generation biofuels’ are biofuels made from sugar, starch, vegetable oil, or animal fats using conventional technology. The basic feedstocks used for the production of first generation biofuels are often seeds or grains such as sunflower seeds which are processed to yield vegetable oil that can be used in biodiesel, or wheat which yields starch that is fermented into bio-ethanol. These feed stocks could instead enter the animal or human food chain. As the global population has increased, their usage in producing biofuels has been criticized for diverting food away from the human food chain thereby leading to food shortages and price rises.

But none of the currently available bio fuel batteries use carbohydrates which are cheaply and abundantly present in easily available agricultural products. Moreover the presently available bio fuel batteries do not support the usage of wide variety of bio materials in the same cell for producing power without changing the structure of the battery. Further none of the presently available batteries can be used continuously for long period of time for producing power.

Hence there is a need for an efficient, inexpensive, eco-friendly biofuel battery that utilizes the largely and easily available bio mass from different species for the production of maximum amount of energy continuously for long time.

The above mentioned shortcomings, disadvantages and problems are addressed herein and which will be understood by reading and studying the following specification.

### OBJECTIVES OF THE EMBODIMENTS

The primary object of the embodiments herein is to provide a simple structured biofuel battery using easily and abundantly available bio fuel in nature.

Another object of the embodiments herein is to provide a biofuel battery using carbohydrate as a bio mass.

Yet another object of the embodiments herein is to provide a biofuel battery which utilizes a large variety of bio fuels without changing the basic structure of the battery.

Yet another object of the embodiments herein is to provide a biofuel battery that is operated for long period of time.

Yet another object of the embodiments herein is to provide a biofuel battery that produces more electricity with least amount of bio fuel.

Yet another object of the embodiments herein is to provide a biofuel battery having a higher resistance of upto 18 hours.

Yet another object of the embodiments herein is to provide a biofuel battery which is eco friendly, clean and cheap.

Yet another object of the embodiments herein is to provide a biofuel battery which is used in room temperature.

Yet another object of the embodiments herein is to provide a biofuel battery in which co-hydrolysis phenomena is used for production of electricity using fuel, oxygen in water and water.

These and other objects and advantages of the present invention will become readily apparent from the following detailed description taken in conjunction with the accompanying drawings.

### SUMMARY

The various embodiments herein provide a biofuel battery comprising: a negative electrode, a positive electrode and water as an electrolyte. According to one embodiment, carbohydrate is the most integral component. The process of preparation, as mentioned in the embodiments herein, provides a more efficient battery producing maximum amount of 1 volt of electricity.

According to one embodiment herein, bio-fuel is used as a negative electrode, oxygen in water is used as a positive electrode and water as an electrolyte.

According to one embodiment herein, a biofuel battery further comprises a plastic cup, a copper wire, a high source of carbohydrate, a carbon fabric and a voltmeter.

According to one embodiment herein, the carbohydrate is the main bio mass for electron creation. The high source of carbohydrate is preferably from mushroom, potatoes, garlic, corn, meat, tomato, date, concentrated juice. The carbon fabric increases the rate of electron transfer in a bio-cell.

According to one embodiment herein, a process of preparing biofuel battery, involves connecting one side of a copper wire to a potato, attaching a carbon fabric to another side of the copper wire and sealing the carbon fabric to the copper wire completely. A plurality of glasses is filled with clean water. The pluralities of glasses are arranged in two rows. A potato in one glass is connected to the water of an adjacent glass with a copper wire. The carbon fabric of a first cell is connected to the potato of the last cell.

According to one embodiment herein, a maximum amount of 1 volt electricity is produced under optimal conditions.

According to another embodiment of the present invention, the most preferable temperature to achieve the maximum amount of electricity is 25° C.

According to one embodiment, a biofuel battery comprises a negative electrode, a positive electrode and water as an electrolyte. The negative electrode is a bio fuel. The bio fuel is a carbohydrate feed. The weight of the carbohydrate feed is 10 grams. The positive electrode is oxygen. The positive electrode is dissolved oxygen in water. The battery further comprises a carbon fabric.

The biofuel battery further comprises a plastic cup, a copper wire, a high source of carbohydrate, a carbon fabric and a voltmeter. The copper wire is an antenna wire. The copper wire is preferably a cupric wire.

The source of carbohydrate is preferably selected from mushroom, potatoes, garlic, corn, meat, tomato, date, concentrated juice. The source of carbohydrate is a skinless potato. The size of carbon fabric is 3*3 cm. The carbon fabric increases the rate of electron transfer in a cell.

According to one embodiment herein, a process is provided for preparing biofuel battery. The process comprises providing a carbohydrate material in each cell. One side of a copper wire is connected to a potato. A carbon fabric is attached to another side of the copper wire and the carbon fabric is sealed to the copper wire completely. A plurality of glasses is filled with clean water. The plurality of glasses is arranged in two rows. The carbohydrate material in one glass in the plurality of glasses is connected to the water in an adjacent glass with the copper wire. A plurality of cells is arranged. The carbon fabric of a first cell is connected to the carbohydrate material of the last cell and to a voltmeter.

The carbohydrate material is selected from a group comprising mushroom, potatoes, garlic, corn, meat, tomato, date, concentrated juice. The carbohydrate material is potato.

The water kept at the plurality of glasses is at ambient temperature level. The water in the plurality of glasses is kept at 25° C.

Each cell has two positive electrodes and two negative electrodes. The carbohydrate material is used as negative electrode and oxygen dissolved in water in the pluralities of electrodes act as positive electrode.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1. illustrates a flow chart explaining the process of preparing biofuel battery according to one embodiment herein.

FIG. 2. illustrates a chart depicting the response of one of the tests with potato.

### DETAILED DESCRIPTION OF THE EMBODIMENTS

In the following detailed description, a reference is made to the accompanying drawings that form a part hereof and in which the specific embodiments that may be practiced is shown by way of illustration. The embodiments herein are described in sufficient detail to enable those skilled in the art to practice the embodiments herein and it is to be understood that the logical, mechanical and other changes may be made without departing from the scope of the embodiments herein. The following detailed description is therefore not to be taken in a limiting sense.

The various embodiments herein provide a biofuel battery comprising a negative electrode, a positive electrode and water as an electrolyte.

According to one embodiment herein, a biofuel battery comprises a plastic cup, a copper wire, a high source of carbohydrate, a carbon fabric and a voltmeter.

According to one embodiment herein, a process of preparing biofuel battery is provided. The process involves connecting one side of a copper wire to a potato, attaching a carbon fabric to another side of the copper wire and sealing the carbon fabric to the copper wire completely. A glass is filled with clean water. The glasses are arranged in two rows. A potato of each cell is connected to the water of an adjacent glass with a copper wire. The carbon fabric of a first cell is connected to the potato of the last cell. A voltmeter is connected across the first cell and the last cell to record a voltage level.

According to one embodiment herein, the biofuel battery is able to produce maximum amount of 1 volt electricity when all the conditions were optimal. With the existing conditions and errors in practice, up to 0.55 volts is produced. One can produce more electricity by connecting a few battery cells together.

According to one embodiment herein, the main factor for creating electron in our cell is the carbohydrate that acts as a fuel, but other nutrients in fuel could produce more electrons. Most of the electrons are made from a reaction between the carbohydrates in fuel and the oxygen in water.

All natural solid materials that have large amount of carbohydrates, like mushroom, potatoes, garlic, corn, meat, tomato, date, concentrated juice are used for fuel without changing the structure of the fuel battery.

But in the cell of the embodiments herein, a carbon fabric is also required as its electrical property causes the absorption of electrons and eliminates scattering of them in water. Thus it is to be certain that all electrons are transferred to the next cells for producing more electricity by using a carbon fabric.

Water is used as a positive pole of the cell in the embodiments herein and the oxygen dissolved in water produces electrons in combination with the carbohydrate of fuel. More the oxygen in water more the electrons are produced. At a natural environment temperature of 25° C., the production of electrons occurs itself.

When the Carbohydrate (the material which contains carbohydrate) is present/immersed in the water, it reacts with the water (the existing oxygen in the molecules of water) in the following manner. Example:

C₁₂H₂₂O₁₁+13H₂O→12CO₂+48H++48e-

The reaction happens in 25° C. and in an inactive condition. At the end, the electrons are released.

According to one embodiment herein, one part of anode and cathode are combined in the fuel cell. Anode and cathode are the electrodes.

Food and existing oxygen in the molecules of water are treated as reactors that play the role of anode and cathode and water is the electrolyte.

In all tests, 100 ml of water and a piece of carbohydrate feed with the weight of 10 g. In the said primary file, changed rate of water has no effect but it should be to the extent that it can submerge the feed in itself completely and feed must be inside a plate.

The temperature-preferred range and the temperature for achieving the accurate results is 25° C. that is equal to the environment temperature and co-hydrolysis phenomena for production of electron in automatic fashion happens under this temperature. Also temperature change of ±5° C. has no effect on this system. Generally, this system functions well in the environment temperature.

The pH-preferred range and the pH for achieving the accurate results in the construction of a new battery in all tests, pH of environment is neutral and no change in witnessed in connection with neutral pH of the environment in none of stages.

During the interaction of the carbohydrate (the material which contains carbohydrate) with the water (the existing oxygen in the molecules of water) at a temperature of 25° C. and in a neutral situation, generate an acidic or base environment but with no change in the neutral nature of water.

According to one embodiment of the present invention, the biofuel battery comprises of: a plastic cup; a copper wire; a high source of carbohydrate; a carbon fabric; and a voltmeter.

The biofuel battery as in the present invention is constructed with 10 plastic cups, 9 copper wires, 10 small pieces of skinless potato (or other fuels having rich source of carbohydrates), 10 pieces of carbon fabric of 3*3 cm and a voltmeter.

The copper wire is an antenna wire most preferably a cupric wire.

According to another embodiment of the present invention, a process of preparing the biofuel battery comprises: connect wires to potatoes, attaching the carbon fabrics to the other side of wires and sure that is completely sealed, filling the glasses from clean water, keeping the glasses in two rows. Then potato in each cell is connected to the water of next glass with wires. A voltmeter connecting the carbon fabric of the first cell and potato of the last cell. Connecting the voltmeter and reading the voltage.

Any other nutrient which has carbohydrate can be used. Soldering the wires to the carbon fabric. For better results keeping the potatoes in the center of cell making sure that water reaches to all part of the fuel.

### Experimental Data

Factors Affecting the Battery:

Fuel Integration

Reducing the fuel integration, for example, breaking the fuel into pieces result that electrons produced were neutralized, and resulting voltage becomes less.

Every cell has two negative and positive poles and for producing more voltage two batteries are used, the non-homonymous poles are connected, and on the contrary, the batteries are neutral and no voltage is achieved. In the fuel cell of the present invention, fuel is the negative pole and water is the positive pole. On breaking the fuel into pieces, it is like that a few small batteries are connected together, but because all have a wireless connection it means that actually homonymous poles are connected and that have neutralized the battery. This case occurs again when several identical or different fuels is used in the battery.

Level Contact with Water

Several tests show that there is a relation between surface of fuel and volume of water. Any increase in contact surface of fuel, increases the rate of electron production. But it is to be noted that increasing in the amount of water is appropriate with fuel surface. For example, if water volume is low and high fuel volume is used for battery cell, some of inside fuel surfaces didn't contact with water and become useless. Also if the water volume is high, electrons are distributed in water and their availability for collection with electrodes becomes less.

Connecting the Cells

At the beginning of the tests it is discovered that when a few batteries are connected to produce a multiple battery, unlike that took long time to reach maximum voltage in a single battery, the multiple batteries immediately reach the maximum voltage but decrease to a smaller level after a short time, that is because of large amount of electrons that our wire can't transfer them to the next cell.

The carbon fabric is used for increasing the rate of electron transferring in cells. It is found that this could control the decreasing the voltage in multiple battery and a multiple battery is produced that gives constant voltage for 17 hours. The reason of this phenomenon is that the cupric wire is used for contacting the cells. One side of wire is in fuel of one cell and the other side is in water of next cell. This causes collection of all electrons that produced from all fuels in final cell's wire that connected to voltmeter.

The embodiments herein are related to a biofuel battery and the process of preparing the same.

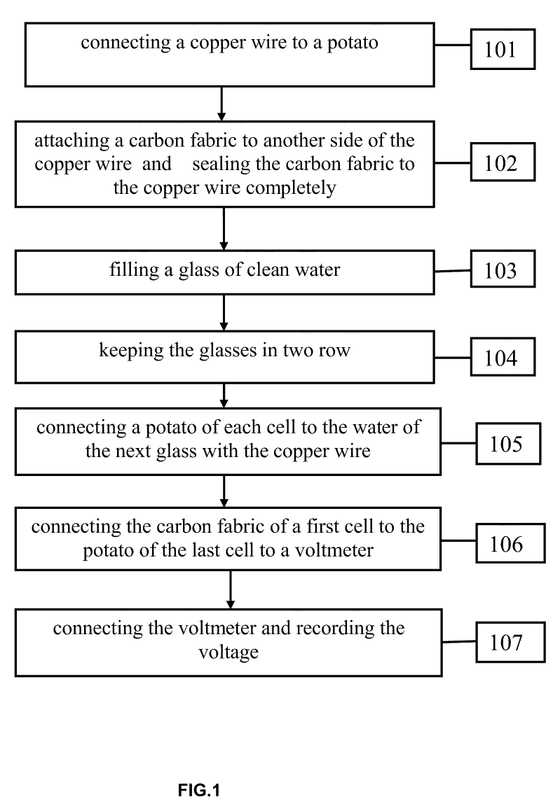

FIG. 1 illustrates a flow chart explaining the process of preparing biofuel battery according to one embodiment herein. With respect to FIG. 1, the process of preparing biofuel battery involves connecting a copper wire to a potato (101), attaching a carbon fabric to another side of the copper wire and sealing the carbon fabric to the copper wire completely (102). Then the glasses are filled with clean water (103). The glasses are kept in two rows (104). A potato of each cell is connected to the water of the next glass with the copper wire (105). The carbon fabric of a first cell is connected to the potato of the last cell (106). A voltmeter is connected across the first and the last cells to measure and record the voltage (107).

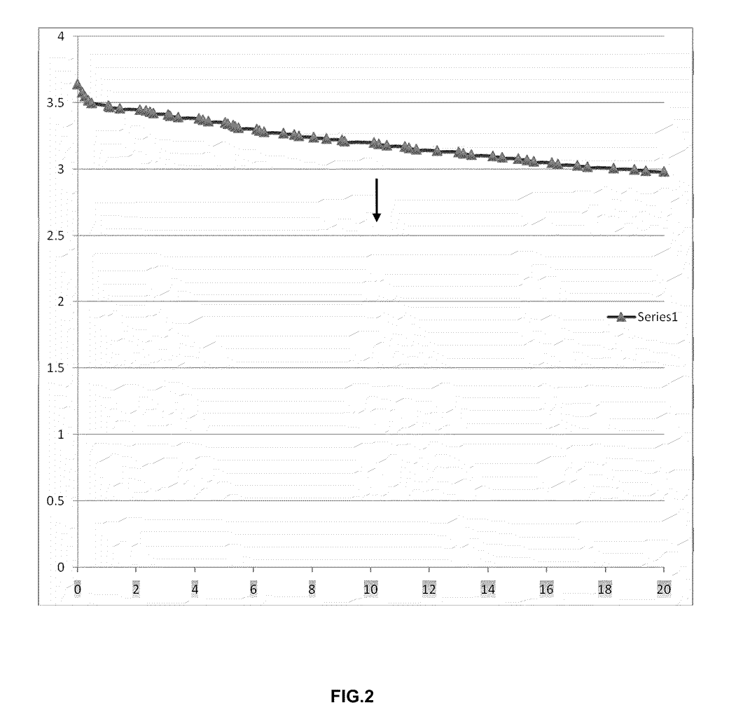

FIG. 2 illustrates a chart showing the result of one of the examinations is adherence with potato.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A biofuel battery consisting of:
a negative electrode;
a positive electrode; and
water as an electrolyte.

2. The biofuel battery as claimed in claim 1, wherein the negative electrode is a bio fuel.

3. The biofuel battery as claimed in claim 1, wherein the bio fuel is a carbohydrate feed.

4. The biofuel battery as claimed in claim 1, wherein the weight of the carbohydrate feed is 10 grams.

5. The biofuel battery as claimed in claim 1, wherein the positive electrode is oxygen.

6. The biofuel battery as claimed in claim 1, wherein the positive electrode is a dissolved oxygen in water.

7. The biofuel battery as claimed in claim 1, wherein the battery further comprises a carbon fabric.

8. The biofuel battery as claimed in claim 1, further comprising:
a plastic cup;
a copper wire;
a high source of carbohydrate;
a carbon fabric; and
a voltmeter.

9. The biofuel battery as claimed in claim 9, wherein the copper wire is an antenna wire.

10. The biofuel battery as claimed in claim 9, wherein the copper wire is preferably a cupric wire.

11. The biofuel battery as claimed in claim 9, wherein the source of carbohydrate is preferably from mushroom, potatoes, garlic, corn, meat, tomato, date, concentrated juice.

12. The biofuel battery as claimed in claim 9, wherein the source of carbohydrate is a skinless potato.

13. The biofuel battery as claimed in claim 9, wherein the size of carbon fabric is 3*3 cm.

14. The biofuel battery as claimed in claim 9, wherein the carbon fabric increases the rate of electron transfer in a cell.

15. A process of preparing biofuel battery consisting steps of:
providing a carbohydrate material in each cell;
connecting one side of a copper wire to the carbohydrate material;
attaching a carbon fabric to another side of the copper wire and sealing the carbon fabric to the copper wire completely;
filling a plurality of glasses with clean water;
arranging the plurality of glasses in two rows;
connecting the carbohydrate material in one glass in the plurality of glasses to the water in an adjacent glass with the copper wire;
arranging a plurality of cells; and
connecting the carbon fabric of a first cell in the plurality of cells to the carbohydrate material of a last cell in the plurality of cells and to a voltmeter.

16. The process of preparing biofuel battery as claimed in claim 15, wherein the carbohydrate material is selected from a group comprising mushroom, potatoes, garlic, corn, meat, tomato, date, concentrated juice.

17. The process of preparing biofuel battery as claimed in claim 15, wherein the carbohydrate material is potato.

18. The process of preparing biofuel battery as claimed in claim 15, wherein the water in the plurality of glasses is at ambient temperature level.

19. The process of preparing biofuel battery as claimed in claim 15, wherein the water in the pluralities of glasses is kept at 25° C.

20. The process of preparing bio fuel battery as claimed in claim 15, wherein each cell has two positive electrodes and two negative electrodes; wherein the carbohydrate material is used as negative electrode and oxygen dissolved in water in the pluralities of electrodes act as positive electrode.
